(19) United States
(12) Patent Application Publication
(10) Pub. No.: US 2003/0007610 A1
(43) Pub. Date: Jan. 9, 2003

(54) Bandwidth sharing apparatus and method

(76) Inventors: Ronald A. Durando, Nutley, NJ (US); James E. Linley, Easton, CT (US)

Correspondence Address: PERMAN & GREEN, 425 POST ROAD, FAIRFIELD, CT, 06824, US

(21) Appl. No.: 10/139,151

(22) Filed: May 2, 2002

Related U.S. Application Data
(60) Provisional application No. 60/288,029, filed on May 2, 2001.

(51) Int. Cl. H04L 12/66

(52) U.S. Cl. 379/88.17; 370/352

(57) ABSTRACT

An apparatus for sharing bandwidth between voice and data includes an on demand dial up router for automatically connecting to an Internet Service Provider using an analog telephone line, first circuitry for multiplexing voice and data signals over the analog telephone line, and second circuitry for allocating bandwidth between the voice and data signals according to a predetermined criteria.

### CROSS-REFERENCE TO RELATED APPLICATIONS

This application claims priority from U.S. Provisional Patent Application No. 60/288,029 filed on May 2, 2001.

### BACKGROUND OF THE INVENTION

1. Field of the Invention

The present invention relates to communications technology and, more particularly, to communication on the internet and by telephone. More particularly, it relates to apparatus and methods for sharing bandwidth between voice and data.

2. Prior Art

Although cable companies are beginning to offer access to the internet by way of high speed fiber optic connections, there are still many regions of the world which do not have access to this technology. In these places, most people connect personal computers to the world wide web (or other networks, such as private networks) by using a telephone line, and a fax/modem built into or associated with their personal computers. When they do so, the telephone line is generally tied up and normal telephone communication can not occur. Further, it is generally necessary to disable certain functions, such as call waiting, to avoid disconnecting the computer from the internet service provider (ISP). This makes it impossible to know when a telephone call is coming in, so that the user can interrupt the internet connection, and pick up the telephone. Of course one obvious solution that some people use is to install a separate telephone line to handle the internet connection, while maintaining their normal telephone service. This solution is undesirable because it increases expenses considerably and requires the use of a telephone line that may not be providing service very often. If everyone followed this practice, it would put a great burden on the telephone infrastructure in terms of all of the additional lines that would be required.

### SUMMARY OF THE INVENTION

It is an object of the invention to provide apparatus and methods for simultaneously using the internet and a telephone with the same telephone line.

It is an other object of the invention to provide an apparatus and method which does so with maximum bandwidth capability.

It is yet another object of the invention to provide such capability at low expense and without unduly encumbering resources.

The invention is directed to a device which permits a single telephone line to be used for both internet dial up service and normal telephone service. The device contains an “On Demand” dial up router that automatically dials the local ISP when any local client (phones/computer) requires access to the internet thereby eliminating the usual dial up sequence. If a telephone call comes in or is to be made, the usual bandwidth of approximately 56 KBPS is reduced by about 32 KBPS (for a high quality telephone connection) to approximately 24 KBPS which is still usable for internet service. When the telephone call is over, the full bandwidth is again available for internet service.

This device provides an extremely significant advantage in that use of the telephone by, for example, teenagers on the internet does not tie up the telephone line completely, thus preventing other family member from receiving or making telephone calls in homes having only one telephone line. It is contemplated that in one embodiment, the invention will be embodied in a card to be plugged into a home PC (or a device that can be connected to a PC) and connected in a manner similar to a modem.

### BRIEF DESCRIPTION OF THE DRAWINGS

The foregoing aspects and other features of the present invention are explained in the following description, taken in connection with the accompanying drawings, wherein:

FIG. 1 is a block diagram of an apparatus in accordance with the invention.

### DETAILED DESCRIPTION OF THE PREFERRED EMBODIMENT

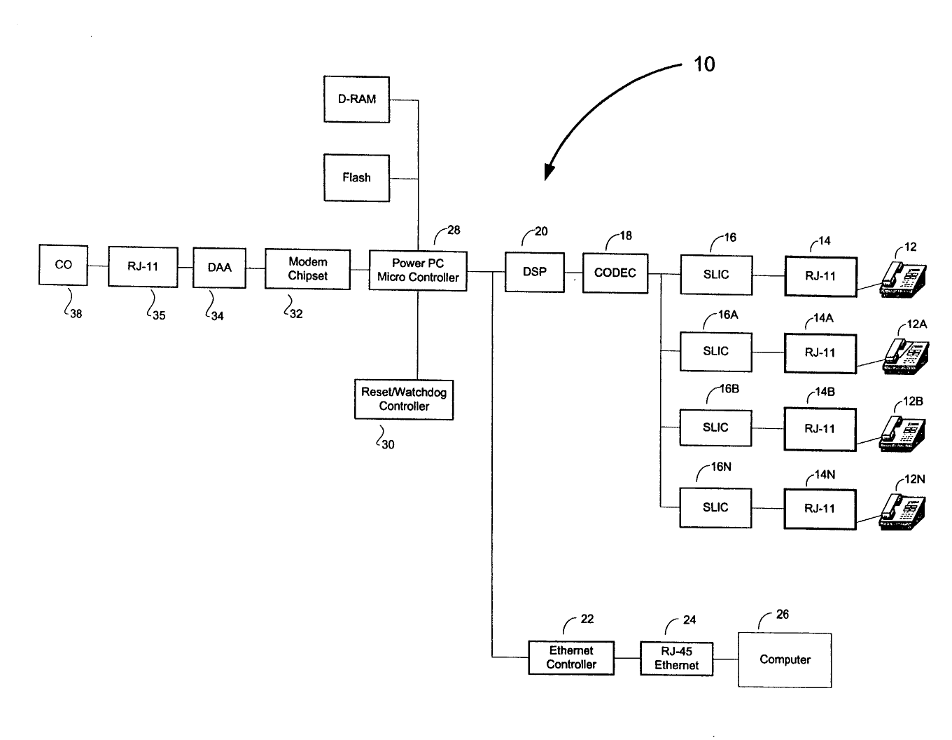

Referring to FIG. 1, there is shown a block diagram of a bandwidth sharing apparatus 10 incorporating features of the present invention. Although the present invention will be described with reference to the single embodiment shown in the drawing, it should be understood that the present invention can be embodied in many alternate forms of embodiments. In addition, any suitable electronic technology, or circuit elements may be used.

A telephone handset 12 is connected to apparatus 10 by means of a standard RJ-11 telephone jack 14. A Subscriber Line Interface Circuit (SLIC) 16, of a type well known in the art, such as a model Si3210 manufactured by PacketPort.com, of Norwalk Conn., interfaces to a codec 18. While this description has been directed to a single user, it will be recognized that there may be additional telephone headsets 12A . . . 12N, additional connectors 14A . . . 14N, and additional SLIC's 16A . . . 16N to accommodate multiple users.

Codec 18 may be any one of several well-known circuits that converts analog data from SLIC 16 to 8 kHz mulaw encoded binary data and such binary encoded data back to analog data.

Data from codec 18 is interchanged with a Digital Signal Processor (DSP) that performs the following functions:

G.729 voice compression/expansion;

G.723 voice compression/expansion;

G.168 echo cancellation;

Automatic gain Control (AGC);

Voice Activity Detection;

Pure tone detection (fax-modem/DTMF); and

Pure tone generation (DTMF and call progress).

A network interface 22, such as an Eithernet® controller, interfaces apparatus 10 to a user's local area network with a 10BT interface. This may be done with an RJ-45 connection 24. An internet user may access the internet by way of a computer 26 on the customer's local area network, or computer 10 may interface directly with apparatus 10 by way of connection 24.

A system microcontroller 28 performs the following functions:

Runs an operating system (such as Linux®);

Supports an MGCP control stack for IP signaling;

Supports an RTP stack for realtime streaming data; and

Supports an on demand router application that multiplexes data from the controller 22 and voice channels onto a PPP modem line as described below. This is significant, as it is in the on demand portion of the apparatus where bandwidth sharing takes place. It is the combination of a packet telephone and an “on demand” router that provides internet access and a virtual telephone connection over a single analog telephone circuit. Microprocessor 28 continuously maintains contact with the internet service provider, and reestablishes the telephone connection, if necessary, providing “always on” internet and telephone service. Bandwidth is dynamically allocated, between the voice and data services. Voice has priority, in that bandwidth is “borrowed” from data handling to provide voice capability, but generally the reverse is not done. Bandwidth may be dynamically allocated by varying the operating parameters of the voice codec and the data packet size.

A system reset and watchdog controller 30 provides power-on reset and failsafe reset service to microcontroller 28.

Microcontroller 28 interchanges data with a modem 32, which may use a standard, commercially available V.90/V.32 modem chipset, which serves to establish a data connection to an internet service provider by means of a two wire analog circuit. Modem 32 may be coupled to such two wire analog line of a public switched telephone network by a DAA device 34 that meets the requirements of FCC Part 98 in the United States or any similar requirements in other countries. An RJ-11 jack 36 connects couples the modem port of apparatus 10 to the public switched telephone network represented by 38.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the invention.

What is claimed is:

1. An apparatus for sharing bandwidth between voice and data comprising:
an on demand dial up router for automatically connecting to an Internet Service Provider using an analog telephone line;
first circuitry for multiplexing voice and data signals over the analog telephone line; and
second circuitry for allocating bandwidth between the voice and data signals according to a predetermined criteria.

2. An method for sharing bandwidth between voice and data comprising:
automatically connecting to an Internet Service Provider using an analog telephone line;
multiplexing voice and data signals over the analog telephone line; and
allocating bandwidth between the voice and data signals according to a predetermined criteria.
